(19) United States
(12) Patent Application Publication
(10) Pub. No.: US 2007/0191014 A1
(43) Pub. Date: Aug. 16, 2007

(54) Authentication mechanism for unlicensed mobile access

(75) Inventors: Haihong Zheng, Coppell, TX (US); Stefano Faccin, Dallas, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/393,344

(22) Filed: Mar. 30, 2006

Related U.S. Application Data
(60) Provisional application No. 60/667,016, filed on Mar. 31, 2005.

(51) Int. Cl. H04Q 7/20

(52) U.S. Cl. 455/438

(57) ABSTRACT

Unlicensed Mobile Access (UMA) authentication techniques are provided. These techniques may use existing authentication mechanisms, such as a Cellular Authentication and Voice Encryption (CAVE) algorithm-based or Message Digest 5 (MD5) algorithm-based authentication mechanism.

### CROSS-REFERENCE TO PROVISIONAL APPLICATION

The present application claims priority from U.S. Provisional Application No. 60/667,016 filed Mar. 31, 2005 and entitled “Authentication Mechanism for Unlicensed Mobile Access,” the contents of which are hereby incorporated herein by reference in their entirety.

### FIELD

Various exemplary embodiments of the invention relate generally to wireless communications, and more particularly to authentication mechanisms for Unlicensed Mobile Access (UMA) technology.

### BACKGROUND

Unlicensed Mobile Access (UMA) technology is a way to provide access to mobile services, such as GSM (Global Systems for Mobile Communications), GPRS (General Packet Radio Services) or CDMA2000 mobile services, over unlicensed spectrum technologies, such as Bluetooth or IEEE 802.11. In this regard, unlicensed mobile access networks (UMANs) have been developed that provide numerous advantages relative to conventional cellular radio access networks. For example, a UMAN may be faster in some situations than conventional cellular radio access networks and/or may be less expensive to utilize than some conventional cellular radio access networks. Thus, it is advantageous in at least some situations to access a core network via a UMAN as opposed to a more conventional cellular radio access network.

Using UMA technology, service providers can enable their subscribers to roam and handover seamlessly between private unlicensed wireless networks, GSM networks, Local Area Networks (LANs), and the public switched telephone network (PSTN) using a dual-mode mobile device. A UMAN generally includes an access point, such as a transceiver, for communicating with a mobile station in an unlicensed spectrum, such as by means of Bluetooth™ brand wireless access technology developed by the Bluetooth Special Interest Group, wireless local area network (WLAN) techniques such as IEEE 802.11, WiMAX techniques such as IEEE 802.16 or the like. As shown in FIG. 1, the access point 10 of the UMAN is connected to an unlicensed network controller 12 via a broadband IP access network 14. The unlicensed network controller 12, in turn, supports communication with the core network 16h/v, 16h such that the mobile station 18 can communicate with the core network 16h/v, 16h ostensibly in the same manner from the user's perspective as if the communications were supported by a conventional cellular radio access network.

For example, in relation to CDMA2000, which is a code-division multiple access (CDMA) version of the IMT-2000 (International Mobile Telecommunications-2000) standard developed by the International Telecommunication Union (ITU), UMA acts as an extension of CDMA2000 mobile services (i.e., all type of services that are supported by the current A1/A2/A5 and A10/A11 interfaces in FIG. 1) to the customer's premises by tunnelling certain CDMA2000 protocols between the customer's premises and the core network over a broadband IP network, and relaying the protocols through an unlicensed radio link (e.g., 802.11, or Bluetooth) inside the customer's premises. UMA is a complement to the traditional CDMA2000 radio coverage used to enhance customer premises coverage and to increase network capacity with potentially lower cost.

A high level view of the UMA functional architecture for CDMA2000 is shown in FIG. 1. The architecture consists of one or more standard access points (APs) 10 and one or more UMA Network Controllers (UNCs) 12, interconnected through a broadband IP network 14. The UNC 12 connects to the CDMA2000 core network 16h/v, 16h through standard CDMA2000 interfaces.

All signalling traffic and user-plane traffic sent between a Mobile Station (MS) 18 and the UNC 12 over the Up interface is protected by an IP security (IPsec) tunnel between the MS 18 and UNC 12. The Up interface supports the ability to authenticate the MS with the UNC (for the purpose of establishing the secure tunnel) based on common security credentials with the CDMA2000 access. The common security credentials consist of a common shared key stored in the MS's User Identification Module (UIM) and in the home system.

Cellular Authentication and Voice Encryption (CAVE) algorithm and Challenge Handshake Authentication Protocol (CHAP)/Password Authentication Protocol (PAP), based on Message Digest 5 (MD5) algorithm, are widely deployed in the CDMA2000 system for Circuit Switched (CS) and Packet Switched (PS) services. Having CAVE-based or MD5-based authentication mechanisms for UMA authentication is, therefore, very attractive to existing CDMA2000 service providers, since it would eliminate the need to support alternative authentication mechanisms, other than those currently existing, for UMA service. However, CAVE-based and MD5-based authentication mechanisms, as well as other authentication protocols used for UMA authentication, suffer from a number of limitations that are described below, and it would therefore be desirable to address these limitations in order to make better use of the existing authentication mechanisms, such as CAVE-based and MD5-based authentication mechanisms, for UMA authentication.

### BRIEF SUMMARY

Various exemplary embodiments of the invention provide an authentication mechanism for Unlicensed Mobile Access (UMA) authentication. While the embodiments are described in terms of Cellular Authentication and Voice Encryption (CAVE) and Message Digest 5 (MD5) authentication protocols, the embodiments are exemplary in nature, and, therefore, do not limit exemplary embodiments of the invention to use with CAVE or MD5authentication protocols. Rather, exemplary embodiments of the invention are generally applicable to other types of authentication protocols.

In order to implement CAVE and MD5 authentication mechanisms between the MS and UNC, the Extensible Authentication Protocol (EAP), which provides an authentication framework that supports multiple authentication methods, is used. The authentication protocol used between the MS and UNC using CAVE or MD5 methods are referred to herein as EAP-CAVE and EAP-MD5, respectively.

According to one aspect of exemplary embodiments of the invention, a method is provided for providing an authentication mechanism for an unlicensed mobile access (UMA) network (UMAN). In one exemplary embodiment, the method includes: (1) receiving a registration request from a mobile station, wherein the request includes a cellular access network identification associated with the mobile station and a UMAN identification also associated with the mobile station; (2) mapping the cellular access network identification to the UMAN identification; and (3) using the mapping to handoff between a cellular access network and the UMAN.

According to another aspect of exemplary embodiments of the invention, a network controller is provided that is capable of providing an authentication mechanism for an unlicensed mobile access (UMA) network (UMAN). In one exemplary embodiment, the network controller includes a processor and a memory in communication with the processor that stores an application executable by the processor. The application may be configured, upon execution, to: (1) receive a registration request from a mobile station, wherein the request includes a cellular access network identification associated with the mobile station and a UMAN identification also associated with the mobile station; (2) map the cellular access network identification to the UMAN identification; and (3) use the mapping to handoff between a cellular access network and the UMAN. In one exemplary embodiment, the network controller comprises a UMAN controller (UNC).

According to yet another aspect of exemplary embodiments of the invention, a system is provided for providing an authentication mechanism for an unlicensed mobile access (UMA) network (UMAN). In one exemplary embodiment, the system includes a mobile station and a network controller. The mobile station of one exemplary embodiment is configured to generate and transmit a registration request including at least two identifications associated with the mobile station. The network controller of this exemplary embodiment is configured to receive the registration request from the mobile station, to correlate the at least two identifications with one another and to handoff between the at least two access networks, based at least in part on the correlation, wherein at least one of the access networks comprises the UMAN.

According to another aspect of exemplary embodiments of the invention, a mobile station is provided. In one exemplary embodiment, the mobile station includes a processor and a memory in communication with the processor that stores an application executable by the processor. The application may be configured, upon execution, to: (1) generate a registration request comprising a cellular access network identification and an unlicensed mobile access network (UMAN) identification associated with the mobile station; and (2) transmit the registration request to a network controller configured to receive the request, to map the cellular access network identification to the UMAN identification and to use the mapping to handoff the mobile station between a cellular access network and a UMAN.

According to yet another aspect of exemplary embodiments of the invention, a computer program product is provided for providing an authentication mechanism for an unlicensed mobile access (UMA) network (UMAN). The computer program product comprises at least one computer-readable storage medium having computer-readable computer program code portions stored therein. In one exemplary embodiment, the computer-readable program code portions include: (1) a first executable portion for receiving a registration request from a mobile station, the request comprising a cellular access network identification associated with the mobile station and a UMAN identification associated with the mobile station; (2) a second executable portion for mapping the cellular access network identification to the UMAN identification; and (3) a third executable portion for using the mapping to handoff between a cellular access network and the UMAN.

According to another aspect of exemplary embodiments of the invention, a system is provided for providing an authentication mechanism for an unlicensed mobile access (UMA) network (UMAN). In one exemplary embodiment, the system includes a mobile station and a network entity in communication with the mobile station. The network entity may be configured to store a registration associated with the mobile station that includes at least two points of attachment for a serving network, a first point of attachment corresponding with a cellular access network, and a second point of attachment corresponding with the UMAN.

### BRIEF DESCRIPTION OF THE DRAWINGS

Having thus described exemplary embodiments of the invention in general terms, reference will now be made to the accompanying drawings, which are not necessarily drawn to scale, and wherein:

FIG. 1 is an example of UMA-CDMA2000 functional architecture;

FIG. 2 is an example of change of pointer to serving system in HLR after handoff/rove-in according to exemplary embodiments of the invention;

FIG. 3 is an example of change of pointer to serving system in AAA server after handoff/rove-in according to exemplary embodiments of the invention;

FIG. 4 is an example of change of pointer to serving AAA server in database after handoff/rove-in according to exemplary embodiments of the invention;

FIG. 5 is an example of special processing in UNC and MS for CDMA to UMA handoff according to one embodiment of the invention; and

FIG. 6 is an example of special processing in UNC and MS for UMA to CDMA handoff according to one embodiment of the invention.

### DETAILED DESCRIPTION

Exemplary embodiments of the invention now will be described more fully hereinafter with reference to the accompanying drawings, in which some, but not all embodiments are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

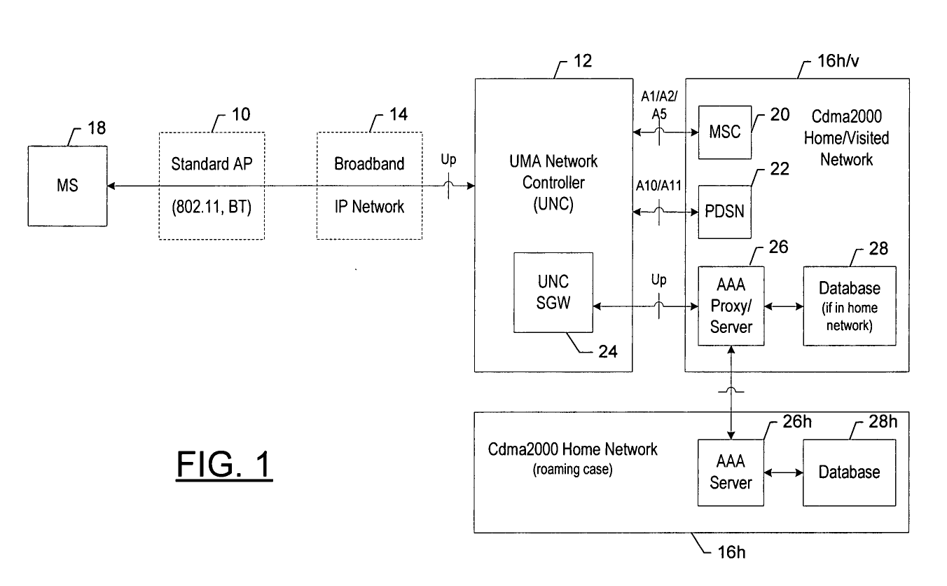

Referring to FIG. 1, an illustration of one type of system that would benefit from embodiments of the invention is provided. The system, method, network controller and mobile station of embodiments will be primarily described in conjunction with mobile communications applications. In this regard, a mobile station is capable of communicating with a core network via either a cellular radio access network, such as a code division multiple access (CDMA) radio access network, or an unlicensed mobile access network (UMAN). While the mobile station may be a mobile telephone, the mobile station may be comprised of other types of wireless end node devices including, for example, pagers, personal digital assistants (PDAs), handheld data terminals, laptop computers and other portable electronic devices. Regardless of its configuration, the mobile station is advantageously capable of operating in at least two modes so as to transmit and receive in a cellular radio mode, such as CDMA mode, and in a UMAN mode. A mobile station capable of operating in two modes is referred to as a dual mode mobile station, such as a dual mode mobile phone capable of operating in CDMA networks and UMANs. The communication interface of a dual mode mobile station, for example, may include a dual mode wireless radio transceiver or separate radio transceivers for operating in cellular radio networks and UMANs.

As one of ordinary skill in the art will recognize, reference is made throughout to CDMA and CDMA2000 for exemplary purposes only and should not be interpreted as limiting the scope of exemplary embodiments of the invention to CDMA, CDMA2000 or any other cellular radio access network or technology. In contrast, other cellular radio access networks and technologies (e.g., GSM, GPRS, Enhanced Data for GSM Evolution (EDGE), Universal Mobile Telecommunications System (UMTS), and the like) may similarly be used without departing from the spirit and scope of exemplary embodiments of the invention.

As shown in FIG. 1, the mobile station of exemplary embodiments is capable of communicating with the core network via either a cellular radio access network, such as a CDMA radio access network, or a UMAN. In this regard, a CDMA radio access network is shown for purposes of illustration but not of limitation, and generally includes a plurality of base transceiver stations for directly communicating with the mobile station. The base transceiver stations also communicate with the base station controller via a private network. The base station controller, in turn, communicates with the core network, which may include the home network of the mobile station as well as one or more visited networks. Thus, the mobile station can communicate with the core network via the cellular radio access network in a conventional manner known to those skilled in the art.

According to exemplary embodiments of the invention, the mobile station can also communicate with the core network via a UMAN. As shown in FIG. 1, the UMAN generally includes an access point 10, such as an unlicensed mobile access (UMA) transceiver. The access point 10 communicates with an unlicensed network controller 12 via a broadband IP network 14. The unlicensed network controller 12, in turn, communicates with the core network which again may include home and visited networks. Typical examples of UMANs include Bluetooth™ networks, wireless local area networks (WLANs) such as WLANs defined by the IEEE 802.11 standard, WiMAX networks defined by the IEEE 802.16 standard, other wireless networks operating by frequencies that lie within unlicensed spectrums, i.e., outside of the spectrums licensed by the Federal Communications Commission (FCC), or wired networks, including, for example, DSL or cable.

The communication between the unlicensed network controller 12 and the core network generally involves communication between the unlicensed network controller 12 and the home network of the mobile station 18, either directly (i.e., where 16h/v is the home network) or indirectly via a visited network (i.e., where 16h/v is the visited network, and 16h is the home network). In either embodiment, the unlicensed network controller communicates with the mobile switching center (MSC) 20 of the home or visited network 16h/v. The MSC 20 is capable of routing calls to and from the mobile station 18 when the mobile station is making and receiving calls. The MSC 20 can also provide a connection to landline trunks when the mobile station 18 is involved in a call. In addition, the MSC 20 can be capable of controlling the forwarding of messages to and from the mobile station 18. The home or visited network 16h/v may also include a packet data serving node (PDSN) 22 for communicating with the unlicensed network controller 12 and for providing access to the Internet, Intranets and/or application servers.

In instances in which the unlicensed network controller 12 is directly communicating with the home network (i.e., 16h/v is the home network), the unlicensed network controller 12 and, more typically, a secure gateway (SGW) 24 of the unlicensed network controller communicates with an authentication, authorization and accounting (AAA) server 26 which, in turn, may access a database 28 containing the necessary data to authenticate a mobile station 18, authorize various services in conjunction with operation of the mobile station 18 and account for the services utilized by the mobile station 18. In instances in which the unlicensed network controller 12 is communicating directly with a visited network (i.e., 16h/v is the visited network), such as in instances in which the mobile station 18 is roaming, the secure gateway 24 of the unlicensed network controller 12 communicates with a AAA proxy 26 of the visited network 16h/v which, in turn, communicates with the AAA server 26h of the home network 16h and its affiliated database 28h in order to provide the necessary authentication, authorization and accounting services for the mobile station 18.

As will be made apparent below, various exemplary embodiments address various issues that otherwise result when, for example, either EAP-CAVE (Extensible Authentication Protocol, Cellular Authentication and Voice Encryption algorithm) or EAP-MD5 (Extensible Authentication Protocol, Message Digest 5 algorithm) is used as an authentication mechanism for Unlicensed Mobile Access (UMA) authentication, and provide solutions for enabling authentication of UMA access by re-using the existing authentication algorithms, such as the CAVE and MD5 algorithms. While embodiments are described in conjunction with 3GPP2 standards, the embodiments are not restricted for use with CDMA2000 networks, and are generally applicable to other types of networks. In addition, while embodiments are described in terms of CAVE-based and MD5-based authentication mechanisms, these embodiments are exemplary in nature and, therefore, do not limit exemplary embodiments of the invention to use with CAVE or MD5 authentication protocols. Rather, embodiments of the invention are generally applicable to other types of authentication protocols.

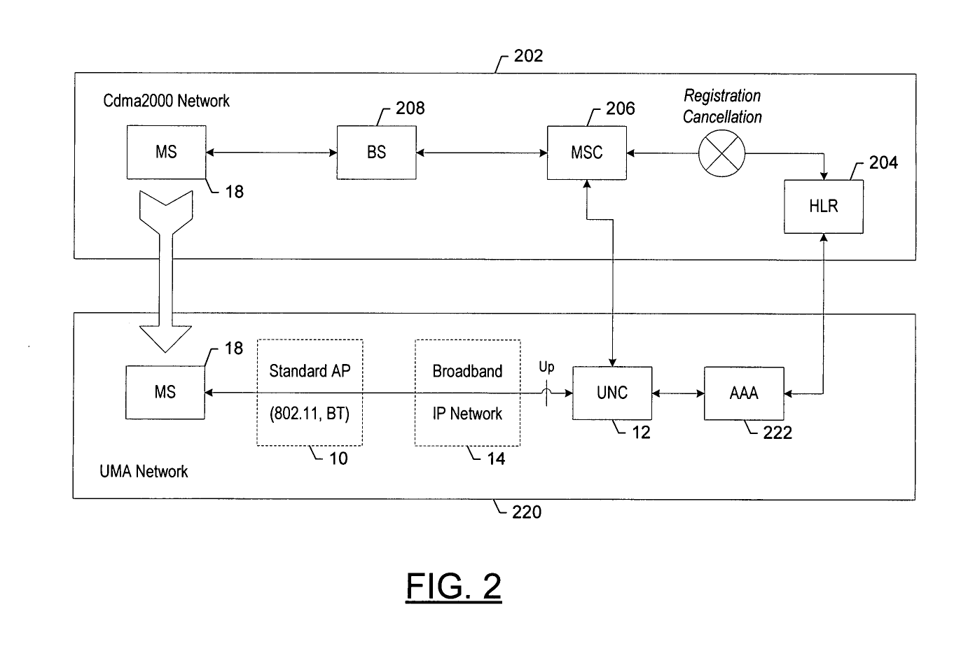

The first issue, Issue 1, discussed below is related to using an authentication mechanism, such as an EAP-CAVE-based authentication mechanism, for UMA authentication as illustrated in FIG. 2, which occurs during the change of pointer of the serving system in a Home Location Register (HLR) after active handoff or idle handoff (rove-in). To illustrate, when the Mobile Station (MS) 18 powers up and acquires CDMA, or similar cellular radio access network, service, it gets authenticated by the CDMA, or similar, network 202, particularly the HLR 204, via a Mobile Switching Center (MSC) 206 and a base station (BS) 208. The HLR 204 keeps a record of the registration of the MS 18 to the serving MSC 206. When the MS 18 hands-off or roves-in from the cellular radio access network 202 to the UMA Network (UMAN) 220, the authentication procedure, such as the CAVE-based authentication procedure, is performed between the MS 18, UNC 12, an Authentication, Authorization and Accounting (AAA) entity 222, and the HLR 204. The serving AAA 222 located in the UMAN signals to the HLR 204 to retrieve the related authentication parameter for the specified MS 18. Such procedure triggers the HLR 204 to cancel the registration from the serving MSC 206 (since the serving AAA 222 in the UMAN 220 is seen by the HLR 204 as another MSC), and records the location of the MS 18 as in the serving network identified by the AAA server 222. As a consequence, the MS 18 is in practice de-registered from the actual serving MSC 206 by the HLR 204 and, as a result, the serving MSC 206 does not deliver any future incoming call to the MS 18, and will reject any call setup attempt by the MS 18 through the UNC 12.

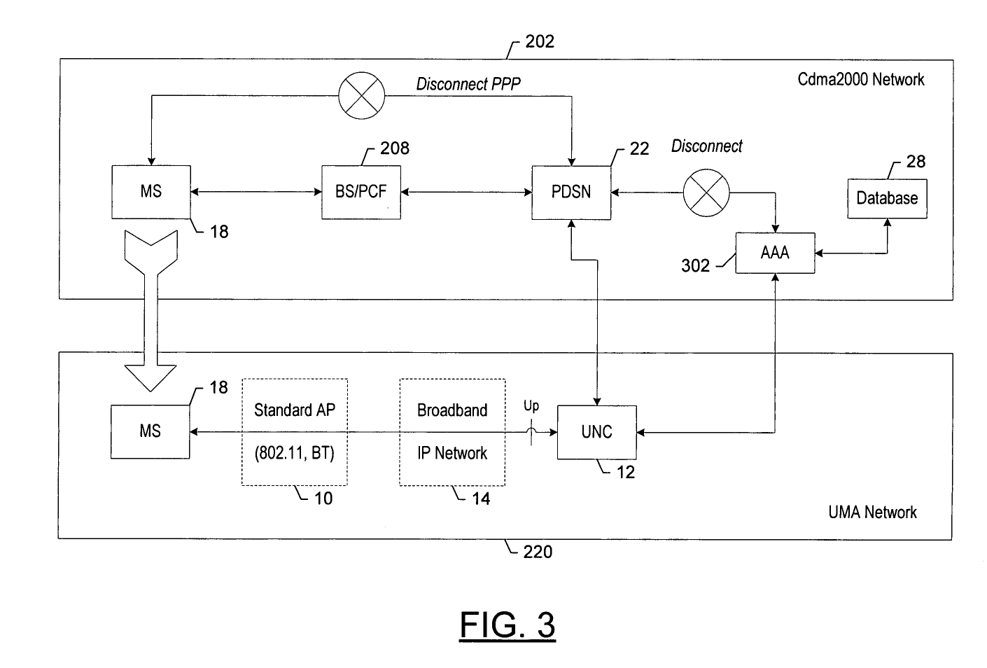

A similar issue, Issue 2, occurs when other authentication mechanisms, such as EAP-MD5 are used as an authentication mechanism for UMA authentication. This issue is related to a change of pointer of the serving system, Network Access Servers (NAS), in an AAA server after handoff or rove-in. It only applies to the case where a single AAA server 302 is used for both Packet Switched (PS) access to cellular radio access networks and UMA access. As shown in FIG. 3, while in cellular radio access mode, the MS 18 uses a CHAP-based authentication mechanism to obtain the simple Internet Protocol (IP) service. Therefore, the serving network pointer (NAS identifier) for the MS 18 in the AAA server 302 is the Packet Data Serving Node (PDSN) 22. When the MS 18 hands-off or roves-in into the UMA network 220 and then performs the authentication, such as the EAP-MD5-based authentication, through the UNC 12, since the NAS identifier in the Radius Access Request is for the UNC 12 instead of the PDSN 22, the AAA server 302 assumes an inter-PDSN handoff occurs, and then changes the serving network pointer for the MS 18 to the UNC 12. The AAA server 302 then sends the Disconnect-Request message to the PDSN 22 to disconnect the MS's Point-to-Point Protocol (PPP) connection. As a result, all the data service delivered to the PDSN 22 or the MS 18 will be dropped.

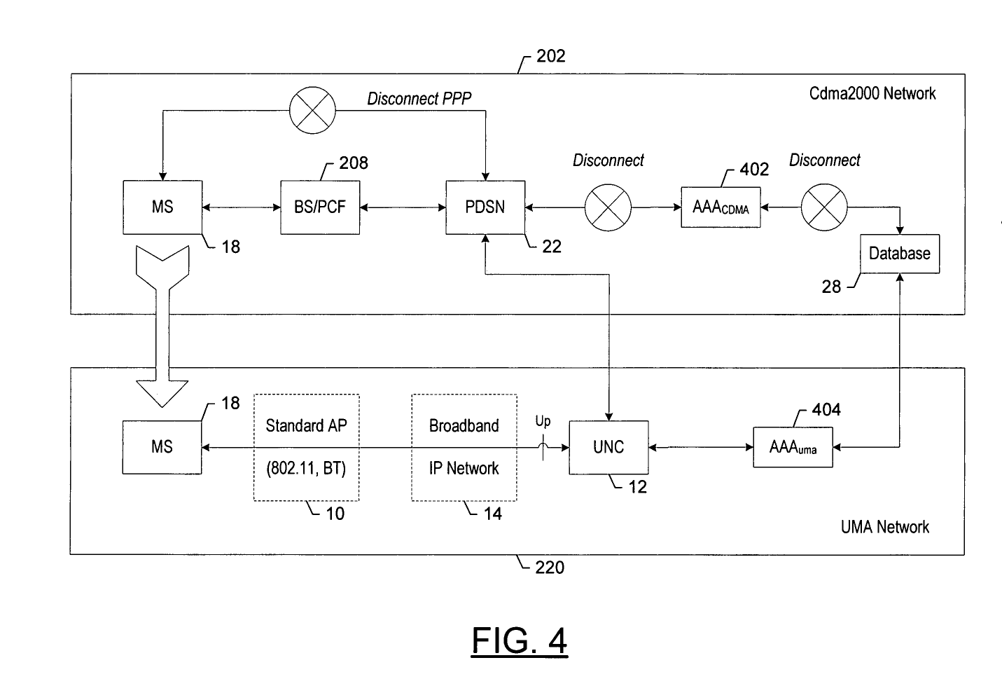

When an authentication mechanism, such as EAP-MD5, is used for UMA authentication, another issue may occur, which is referred to as Issue 3. It is related to a change of pointer of the serving AAA server in the database after handoff or rove-in. This potential issue only applies to the case where the AAA servers for UMA access and cellular radio access are different while sharing the same database. The database contains information related to the mobile station that is similar to that stored in an HLR. The information may include, for example, authentication keys, user profiles, and the like. As shown in FIG. 4, while in the cellular radio access mode, the MS uses a CHAP-based authentication mechanism to obtain the simple IP service though the cellular radio access AAA server (termed as AAA_{CDMA}) 402. Therefore, the serving AAA pointer for the MS 18 in the database 28 is the AAA_{CDMA} 402. When the MS 18 hands-off or roves-in into the UMA network 220 and then performs the authentication, such as the EAP-MD5-based authentication through the AAA server for UMA access (termed as AAAᵤₘₐ.) 404, the pointer to the serving AAA server for the MS 18 in the database 28 may be changed to AAAᵤₘₐ 404, and the database 28 deregisters with AAA_{CDMA} 402, which in turn triggers AAA_{CDMA} 402 to deregister with the PDSN 22. As a consequence, all of the data service delivered to the PDSN 22 for the MS 18 will be dropped. However, the interface between the AAA servers and database is not an open interface at the current stage. Whether or not the database is able to maintain two or more AAA attachment points for a single MS is purely implementation specific and is not specified in the standard. Therefore, the CDMA database, in order to be enhanced for UMA access, should be designed to support such feature.

Various exemplary embodiments provide solutions to the issues discussed above in order to enable authentication of UMA access by re-using the existing authentication algorithms, such as the CAVE and MD5 algorithms. The solutions to the issues, which are mentioned above, are identified as Approaches 1, 2, 3, 4, 5, and 6 listed in the following. Approach 1 and Approach 2 are proposed to solve Issue 1. Approach 3 and Approach 4 are for solving Issue 2. And, Approach 5 and Approach 6 are examples of the solutions to Issue 3.

In one embodiment of Approach 1, involving a single MS, an HLR that supports two points of attachment from the serving network—one for cellular radio access network (e.g., CDMA) services and one for UMA services—is provided. When the MS tries to get authenticated from the UMA network, its registration with the MSC should be maintained. According to this approach, the IS-41 HLR is modified so as to support two points of attachment of serving networks for a single MS, and the interface between the AAA server and the HLR may be optionally enhanced to indicate the UMA service as well.

In an embodiment of Approach 2, which provides an alternative solution to Issue 1, each dual mode MS is assigned with two identities with one identity for a cellular radio access network (e.g., a CDMA network) and another identify for a UMAN. Each identity can include Electronic Serial Number (ESN) and International Mobile Subscriber Identity (IMSI)—termed as ESN_{CDMA}, ESNᵤₘₐ, IMSI_{CDMA} and IMSIᵤₘₐ, respectively. Only the identity in the cellular radio access network is used to reach the MS. When the MS authenticates in the cellular radio access network, IMSI_{CDMA} and ESN_{CDMA} are used, while when the MS authenticates in the UMA network, IMSIᵤₘₐ and optionally ESNᵤₘₐ are used instead. Under this approach, the HLR keeps two pointers to the serving networks for a single MS but with two different MS identities. No modification to the HLR is required. The cellular radio access network entities such as BS and MSC are only aware of the MS's identity in the cellular radio access network, while the UNC and MS use both of the MS's cellular radio access network and UMA identities. According to this embodiment, some special handling between the UNC and MS may be required to allow a handoff between the cellular radio access network and a UMAN. This special handling is discussed in detail below.

In an embodiment of Approach 3 involving a single MS, a solution to Issue 2 discussed above is provided. According to this embodiment, an AAA entity that supports two points of attachment from the serving network—one for cellular radio access network (e.g., CDMA) services and one for UMA services—is provided. When the MS tries to get authenticated from the UMA network, its registration with the PDSN should be maintained. As such, the AAA server in the cellular radio access network (e.g., the CDMA2000 network) must be capable of supporting two points of attachment of serving networks (NAS) for a single MS.

In one embodiment of Approach 4, which provides an alternative solution to Issue 2, two sets of MS identities for a single MS are used. This embodiment is similar to that discussed above with respect to Approach 2. According to this embodiment, each dual mode MS is assigned with two identities, termed as IMSI_{CDMA} and IMSIᵤₘₐ, respectively. Only the CDMA (or similar cellular radio access network) identity is used to reach the MS. When the MS authenticates in the CDMA, or similar, network, IMSI_{CDMA} is used, while when authenticating in the UMA network, IMSIᵤₘₐ is used instead. Under this approach, the AAA keeps two pointers to the serving networks (NAS) for a single MS but with two different MS identities. No modification to a current AAA is required. The cellular radio access network entities such as the BS and the AAA are only aware of the MS's identity in the cellular radio access network, while the UNC and MS use both of the MS's cellular radio access network and UMA identities. Some special handling between the UNC and MS may be required to allow a handoff between a cellular radio access network and a UMAN, which is discussed in detail below.

In an embodiment of Approach 5, which provides a solution to the third issue discussed above, the cellular radio access network (e.g., CDMA) database is designed to support an open interface with the AAA server. Currently, the interface between the AAA server and cellular radio access network database is not an open interface. Whether or not the database is able to maintain two or more AAA attachment points for a single MS is purely implementation specific and is not specified in the standard. Therefore, the cellular radio access network database, in order to be enhanced for UMA access, should be designed to support such feature.

In an embodiment of Approach 6, an alternative solution to Issue 3 is provided, wherein two sets of MS identities are used for a single MS. This embodiment is similar to embodiments discussed above with respect to the alternative approaches for Issues 1 and 2. In this embodiment, each dual mode MS is assigned with two identities, termed as IMSI_{CDMA} and IMSIᵤₘₐ, respectively. Only the CDMA (or similar cellular radio access network) identity is used to reach the MS. When the MS authenticates in the CDMA, or similar, network, IMSI_{CDMA} is used, while authenticating in the UMA network, IMSIᵤₘₐ is used instead. With such mechanism, the database keeps two pointers to the serving networks (AAA server) for a single MS but with two different MS identities. The cellular radio access network entities such as the BS and MSC are only aware of the MS's identity in the cellular radio access network, while the UNC and MS use both of the MS's cellular radio access network and UMA identities. As in the above related embodiments, some special handling between the UNC and MS may be required to allow a handoff between the cellular radio access network and a UMAN.

The special handlings between the UNC and MS to allow a handoff between a cellular radio access network and a UMAN, as required by various embodiments discussed above, will now be described in detail.

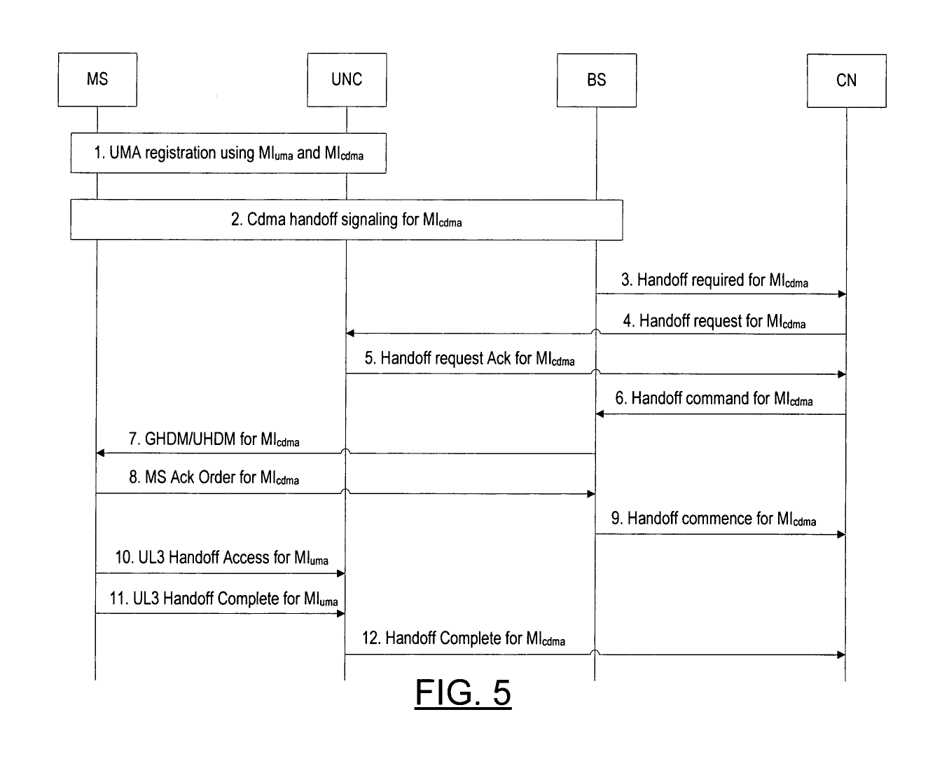

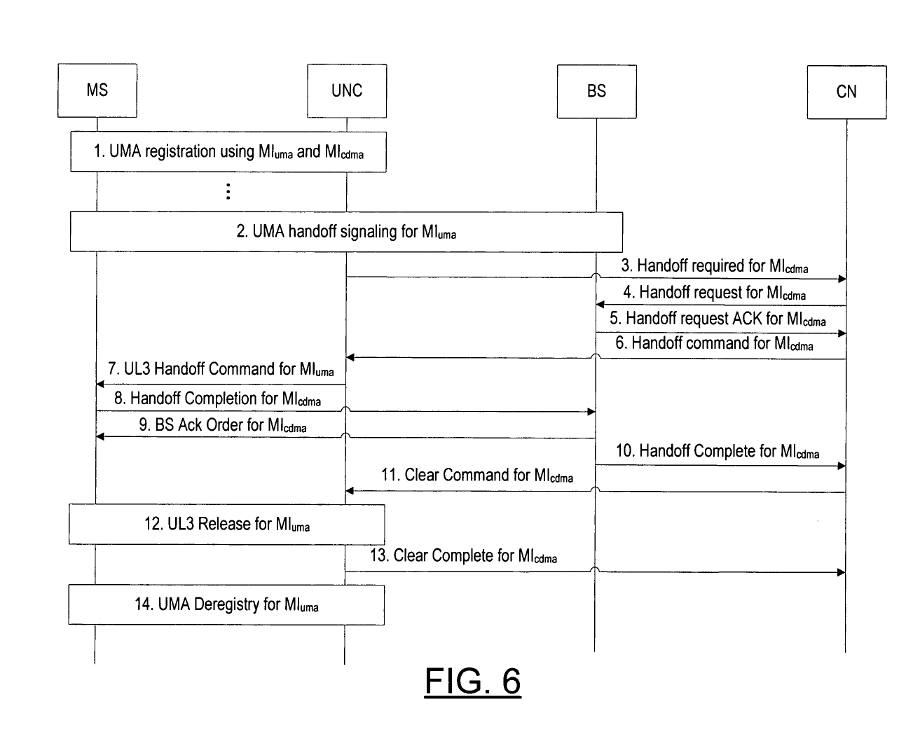

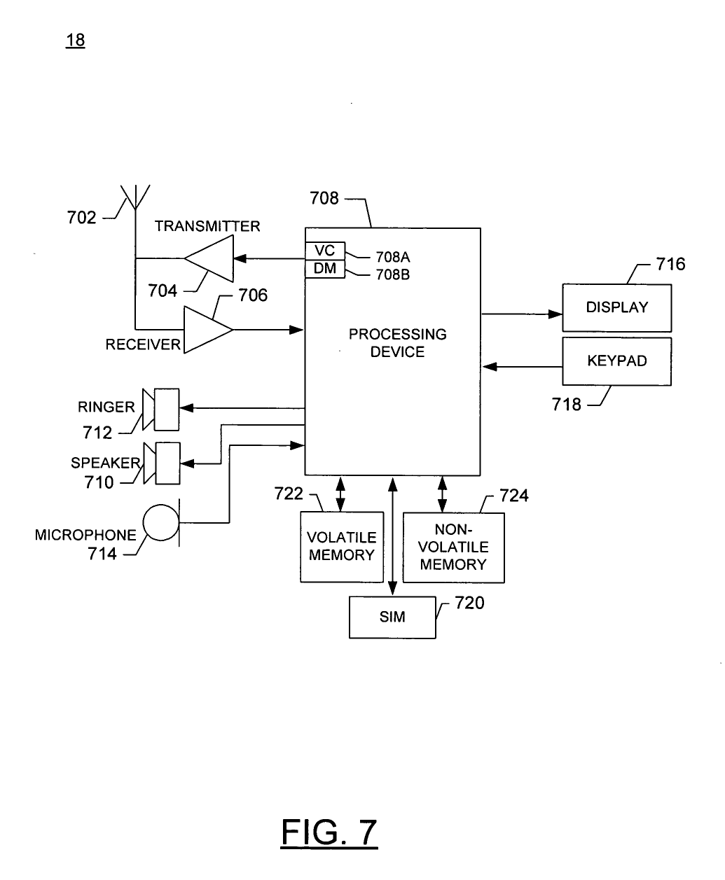

When registering with the UMA network, the MS should signal not only the MS identity used in the UMAN, but also that for the cellular radio access network (e.g., CDMA network). See step 1 of FIGS. 5 and 6. More specifically, the UMA Layer 3 (UL3) Registration Request should contain ESN_{CDMA}, ESNᵤₘₐ, IMSI_{CDMA} and IMSIᵤₘₐ. Note that if the UNC contains the mapping between ESN and IMSI, only IMSI_{CDMA} and IMSIᵤₘₐ are sent, since the corresponding ESNs may be determined from the mapping. The UNC keeps the mapping between the two sets of MS identities. In a cellular radio access network (e.g., a CDMA network), either ESN or IMSI, or both are used to identify the MS. Without specifying which is used, the following text uses Mobile Identity (MI) to represent MS's identity. MIᵤₘₐ represents IMSIᵤₘₐ in the UMA case, while MI_{CDMA} could be IMSIᵤₘₐ, or ESN_{CDMA}, or both in the case of a cellular radio access network.

As illustrated in FIG. 5, in which the MS is initially communicating via the cellular radio access network as shown in step 2, when handoff from cellular radio access to UMA occurs as triggered by the Handoff Required message (step 3), the core network (CN), and, in particular, the MSC, sends the MS's identity in the cellular radio access network (i.e., MI_{CDMA}) to the UNC in the Handoff Request Message over the A1 interface (step 4). The UNC acknowledges the request, in Step 5, by transmitting a handoff request acknowledgement including MI_{CDMA}. The MSC then requests that the BS send the handoff request to the MS (step 6). In response, the BS requests that the MS handoff to the UNC using MI_{cdma} (step 7). The MS acknowledges the request (step 8), and in step 9, the BS acknowledges the MSC's request sent in step 6. When the UNC receives the UL3 Handoff Access and UL3 Handoff Complete messages from the MS identified by MIᵤₘₐ (steps 10 and 11), based on the MI_{CDMA}-MIᵤₘₐ mapping obtained during the registration period as shown in step 1, the UNC identifies the handing-off MS's cellular access network identity (i.e., MI_{CDMA}), and sends Handoff Complete Message corresponding to MI_{CDMA} over the A1 interface (step 12).

As illustrated in FIG. 6 in which the MS is initially communicating via the UMA network as shown in step 2, when handoff from UMA to CDMA, or other similar cellular radio access network, occurs, the UNC maps MIᵤₘₐ to MI_{CDMA} based on the mapping obtained from step 1, and then sends the MI_{CDMA} in the Handoff Required Message to the MSC (step 3). The MSC then instructs the BS to prepare for the handoff based on MI_{CDMA} (step 4, 5). When the UNC receives a Handoff Command for MI_{CDMA} (step 6), the UNC uses the MI_{CDMA} to MIᵤₘₐ mapping to determine the MIᵤₘₐ, based on which the UL3 handoff command is issued to the MS (step 7). After handoff to the cellular radio access network completes (step 8-10), a Clear Command for MI_{CDMA} is sent from the MSC to the UNC (step 11). The UNC again uses the MI_{CDMA} to MIᵤₘₐ mapping and releases the UL3 connection with the MS identified by MIᵤₘₐ (steps 12), and then sends Clear Complete for MI_{CDMA} to the MSC (step 13). Triggered by the UL3 deregistration procedure, the UNC should contact the AAA server to deregister the MS identified by MIᵤₘₐ. The AAA server should in turn deregister the MS with MIᵤₘₐ from the HLR) (step 14).

Reference is now made to FIG. 7, which illustrates one type of electronic device that would benefit from embodiments. As shown, the electronic device may be a mobile station 18, and, in particular, a cellular telephone. It should be understood, however, that the mobile station illustrated and hereinafter described is merely illustrative of one type of electronic device that would benefit from exemplary embodiments and, therefore, should not be taken to limit the scope of exemplary embodiments of the invention. While several embodiments of the mobile station 18 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments.

The mobile station includes various means for performing one or more functions in accordance with exemplary embodiments, including those more particularly shown and described herein. It should be understood, however, that one or more of the entities may include alternative means for performing one or more like functions, without departing from the spirit and scope of exemplary embodiments of the invention. More particularly, for example, in order to support the authentication mechanisms of the various embodiments, the mobile station of one embodiment includes a memory for storing both its CDMA, or similar cellular radio access network, identity and its UMA identity, such as the ESN_{CDMA}, ESNᵤₘₐ, IMSI_{CDMA} and IMSIᵤₘₐ described above, and a controller for directing communications with the cellular radio access network and the UMAN.

In addition to an antenna 702, the mobile station 18 can also include a transmitter 704, receiver 706, and controller 708 or other processing element or computing device that provides signals to and receives signals from the transmitter 704 and receiver 706, respectively. These signals include the signaling information in accordance with the air interface standard of the applicable cellular system, and also user speech and/or user generated data. In this regard, the mobile station can be capable of operating with one or more air interface standards, communication protocols, modulation types, and access types. As described above, the mobile station is dual mode and is therefore generally capable of operating in accordance with both cellular radio protocols, such as CDMA protocols, including, for example, those defined by IS-95, CDMA2000 or the like, and the wireless communications protocols supported by a UMAN, such as Bluetooth™, WLAN, WiMAX or like technologies.

It is understood that the controller 708 includes the circuitry required for implementing the video, audio and logic functions of the mobile station 18 and is capable of executing application programs for implementing the functionality discussed herein. For example, the controller 708 may be comprised of a digital signal processor device, a microprocessor device, and various analog-to-digital converters, digital-to-analog converters, and other support circuits. The control and signal processing functions of the mobile station are allocated between these devices according to their respective capabilities. The controller 708 can additionally include an internal voice coder (VC) 708A, and may include an internal data modem (DM) 708B. Further, the controller 708 may include the functionality to operate one or more software programs, which may be stored in memory (described below).

The mobile station also comprises a user interface, which may include a conventional earphone or speaker 710, a ringer 712, a microphone 714 and/or a display 716, all of which are coupled to the controller 708. The user input interface, which allows the mobile station to receive data, can comprise any of a number of devices allowing the mobile station to receive data, such as a keypad 718, a touch display (not shown), a microphone 714, or other input device. In embodiments including a keypad, the keypad includes the conventional numeric (0-9) and related keys (#, *), and other keys used for operating the mobile station. Although not shown, the mobile station can include a battery for powering the various circuits that are required to operate the mobile station.

The mobile station 18 can also include one or more means for sharing and/or obtaining data. For example, the mobile station can include a short-range radio frequency (RF) transceiver or interrogator so that data can be shared with and/or obtained from electronic devices in accordance with RF techniques. The mobile station can additionally, or alternatively, include other short-range transceivers, such as, for example an infrared (IR) transceiver, a Bluetooth (BT) transceiver operating using Bluetooth brand wireless technology developed by the Bluetooth Special Interest Group and/or a WLAN transceiver for communicating in accordance with one or more wireless networking techniques, including WLAN techniques such as IEEE 802.11, WiMAX techniques such as IEEE 802.16 or the like. The mobile station can therefore additionally or alternatively be capable of transmitting data to and/or receiving data from electronic devices in accordance with such techniques.

The mobile station can further include memory, such as a subscriber identity module (SIM) 720, a removable user identity module (R-UIM) (not shown), or the like, which typically stores information elements related to a mobile subscriber. In addition, the mobile station can include other removable and/or fixed memory. In this regard, the mobile station can include volatile memory 722, such as volatile Random Access Memory (RAM) including a cache area for the temporary storage of data. The mobile station can also include other non-volatile memory 724, which can be embedded and/or may be removable. The non-volatile memory can additionally or alternatively comprise an EEPROM, flash memory or the like. The memories can store any of a number of software applications, instructions, pieces of information, and data, used by the mobile station 18 to implement its functions. For example, the memories can store an identifier, such as an international mobile equipment identification (IMEI) code, international mobile subscriber identification (IMSI) code, mobile station integrated services digital network (MSISDN) code (mobile telephone number), Internet Protocol (IP) address, Session Initiation Protocol (SIP) address or the like, capable of uniquely identifying the mobile station. In addition, the memories can store both the CDMA, or similar network, identity and the UMA identity of the mobile station 18, such as the ESN_{CDMA}, ESNᵤₘₐ, IMSI_{CDMA} and IMSIᵤₘₐ described above. The memory can also store content. The memory may, for example, store computer program code for an application and other computer programs. For example, as discussed above, in one embodiment, the memory may store computer program code for generating and transmitting a registration request to a UMA controller (UNC) that includes identities associating the mobile station with a cellular access network and a UMAN, such that these identities can be mapped to one another by the UNC and used when handing off the mobile station between the cellular access network and the UMAN (i.e., the identities can be used when authenticating the mobile station to the respective networks).

One advantage of the various embodiments is that the proposed solutions enable a CDMA2000, or similar, service provider to use existing authentication mechanisms (i.e., CAVE and MD5) for UMA service, without significant modifications or additions in their HLR and database products.

As will be recognized by those of skill in the art, various embodiments may be implemented in software comprising a plurality of computer program instructions that may be stored in a computer-readable memory, which is capable of directing a computer or other computing or processing device such as those included within, for example, a mobile station, such as a mobile phone, personal digital assistant (PDA) or mobile personal computer (PC), a base station, base station equipment, a base station component, the UNC, a wireless network controller, the AAA server, the HLR, equipment that supports cellular radio access network (e.g., CDMA) and/or UMA user registration, a database, or the like, to perform the various functions defined by the software. Various embodiments may be used in a cellular radio access network, such as CDMA and CDMA-related wireless networks, such as CDMA2000 wireless networks. Also, various exemplary embodiments are suitable for standardization in 3GPP2 systems.

As described above and as will be appreciated by one skilled in the art, embodiments may be configured as a system, method, network controller or mobile station. Accordingly, embodiments may be comprised of various means including entirely of hardware, entirely of software, or any combination of software and hardware. Furthermore, embodiments may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments set forth herein will come to mind to one skilled in the art to which exemplary embodiments of the invention pertain having the benefit of the teachings presented in the foregoing descriptions and the associated drawings. Therefore, it is to be understood that the exemplary embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing an authentication mechanism for an unlicensed mobile access network, said method comprising:
receiving a registration request from a mobile station, said request comprising a cellular access network identification associated with the mobile station and an unlicensed mobile access network identification associated with the mobile station;
mapping the cellular access network identification to the unlicensed mobile access network identification; and
using the mapping to handoff between a cellular access network and the unlicensed mobile access network.

2. The method of claim 1, wherein the cellular access network identification is used to contact the mobile station and to authenticate the mobile station to the cellular access network, and wherein the unlicensed mobile access network identification is used to authenticate the mobile station to the unlicensed mobile access network.

3. The method of claim 1, wherein respective cellular access network and unlicensed mobile access network identifications comprise at least one of an electronic serial number or an international mobile subscriber identity associated with the mobile station.

4. The method of claim 1 further comprising:
receiving a request to handoff the mobile station from the cellular access network to the unlicensed mobile access network, said handoff request comprising the cellular access network identification associated with the mobile station.

5. The method of claim 4 further comprising:
receiving a first handoff complete message comprising the unlicensed mobile access network identification associated with the mobile station.

6. The method of claim 5 further comprising:
determining the cellular access network identification associated with the mobile station based at least in part on the unlicensed mobile access network identification included in the first handoff complete message; and
transmitting a second handoff complete message comprising the cellular access network identification.

7. The method of claim 1 further comprising:
determining the cellular access network identification associated with the mobile station based at least in part on the mapping; and
generating a request to handoff the mobile station from the unlicensed mobile access network to the cellular access network, said handoff request comprising the cellular access network identification associated with the mobile station.

8. The method of claim 7 further comprising:
receiving a first handoff command comprising the cellular access network identification associated with the mobile station;
determining the unlicensed mobile access network identification associated with the mobile station based at least in part on the cellular access network identification included in the first handoff command; and
transmitting a second handoff command comprising the unlicensed mobile access network identification.

9. The method of claim 8 further comprising:
releasing a connection between the unlicensed mobile access network connection and the mobile station identified by the unlicensed mobile access network identification;
determining the cellular access network identification associated with the mobile station based at least in part on the unlicensed mobile access network identification; and
transmitting a clear complete message comprising the cellular access network identification.

10. A network controller capable of providing an authentication mechanism for an unlicensed mobile access network, said controller comprising:
a processor; and
a memory in communication with the processor, said memory storing an application executable by the processor, wherein the application is configured, upon execution, to:
receive a registration request from a mobile station, the request comprising a cellular access network identification associated with the mobile station and an unlicensed mobile access network identification associated with the mobile station;
map the cellular access network identification to the unlicensed mobile access network identification; and
use the mapping to handoff between a cellular access network and the unlicensed mobile access network.

11. The network controller of claim 10, wherein the cellular access network identification is used to contact the mobile station and to authenticate the mobile station to the cellular access network, and wherein the unlicensed mobile access network identification is used to authenticate the mobile station to the unlicensed mobile access network.

12. The network controller of claim 10, wherein respective cellular access network and unlicensed mobile access network identifications comprise at least one of an electronic serial number or an international mobile subscriber identity associated with the mobile station.

13. The network controller of claim 10, wherein the application is further configured, upon execution, to:
receive a request to handoff the mobile station from the cellular access network to the unlicensed mobile access network, said handoff request comprising the cellular access network identification associated with the mobile station.

14. The network controller of claim 13, wherein the application is further configured, upon execution, to:
receive a first handoff complete message comprising the unlicensed mobile access network identification associated with the mobile station.

15. The network controller of claim 14, wherein the application is further configured, upon execution, to:
determine the cellular access network identification associated with the mobile station based at least in part on the unlicensed mobile access network identification included in the first handoff complete message; and
transmit a second handoff complete message comprising the cellular access network identification.

16. The network controller of claim 10, wherein the application is further configured, upon execution, to:
determine the cellular access network identification associated with the mobile station based at least in part on the mapping; and
generate a request to handoff the mobile station from the unlicensed mobile access network to the cellular access network, said handoff request comprising the cellular access network identification associated with the mobile station.

17. The network controller of claim 16, wherein the application is further configured, upon execution, to:
receive a first handoff command comprising the cellular access network identification associated with the mobile station;
determine the unlicensed mobile access network identification associated with the mobile station based at least in part on the cellular access network identification included in the first handoff command; and
transmit a second handoff command comprising the unlicensed mobile access network identification.

18. The network controller of claim 17, wherein the application is further configured, upon execution, to:
release a connection between the unlicensed mobile access network connection and the mobile station identified by the unlicensed mobile access network identification;
determine the cellular access network identification associated with the mobile station based at least in part on the unlicensed mobile access network identification; and
transmit a clear complete message comprising the cellular access network identification.

19. The network controller of claim 10, wherein the network controller comprises an unlicensed mobile access network controller.

20. A system for providing an authentication mechanism for an unlicensed mobile access network, said system comprising:
a mobile station configured to generate and transmit a registration request, said registration request comprising at least two identifications associated with the mobile station; and
a network controller configured to receive the registration request from the mobile station, the network controller further configured to correlate the at least two identifications with one another and to handoff between at least two access networks, based at least in part on the correlation, wherein at least one of the access networks comprises the unlicensed mobile access network.

21. The system of claim 20, wherein the at least two identifications comprise a cellular access network identification and an unlicensed mobile access network identification.

22. The system of claim 21 further comprising:
a mobile switching center configured to generate and transmit a handoff request for handoff of the mobile station from a cellular access network to the unlicensed mobile access network, the handoff request comprising the cellular access network identification associated with the mobile station, wherein the network controller is further configured to receive the handoff request.

23. The system of claim 22, wherein the mobile station is further configured to transmit a first handoff complete message comprising the unlicensed mobile access network identification, and wherein the network controller is further configured to receive the first handoff complete message.

24. The system of claim 23, wherein the network controller is further configured to determine the cellular access network identification associated with the mobile station based at least in part on the unlicensed mobile access network identification included in the first handoff complete message, and to transmit a second handoff complete message comprising the cellular access network identification.

25. The system of claim 22, wherein the network controller is further configured to generate and transmit a request for handoff of the mobile station from the unlicensed mobile access network to a cellular access network, the handoff request comprising the cellular access network identification.

26. The system of claim 25, wherein the mobile switching center is further configured to receive the handoff request from the network controller and to transmit a first handoff command to the network controller, said handoff command comprising the cellular access network identification associated with the mobile station.

27. The system of claim 26, wherein the network controller is further configured to receive the first handoff command, to determine the unlicensed mobile access network identification based at least in part on the cellular access network identification included in the first handoff command, and to transmit a second handoff command to the mobile station, said second handoff command comprising the unlicensed mobile access network identification.

28. The system of claim 27, wherein the mobile station is further configured to receive the second handoff command, to determine the cellular access network identification based at least in part on the unlicensed mobile access network identification included in the second handoff command, and to transmit a handoff complete message comprising the cellular access network identification.

29. The system of claim 28, wherein the network controller is further configured to release a connection between the unlicensed mobile access network connection and the mobile station identified by the unlicensed mobile access network identification, to determine the cellular access network identification associated with the mobile station based at least in part on the unlicensed mobile access network identification, and to transmit a clear complete message to the mobile switching center, said clear complete message comprising the cellular access network identification.

30. A mobile station comprising:
a processor; and
a memory in communication with the processor, the memory storing an application executable by the processor, wherein the application is configured, upon execution, to:
generate a registration request comprising a cellular access network identification and an unlicensed mobile access network identification associated with the mobile station; and
transmit the registration request to a network controller configured to receive the request, to map the cellular access network identification to the unlicensed mobile access network identification and to use the mapping to handoff the mobile station between a cellular access network and an unlicensed mobile access network.

31. The mobile station of claim 30, wherein the cellular access network identification is used to contact the mobile station and to authenticate the mobile station to the cellular access network, and wherein the unlicensed mobile access network identification is used to authenticate the mobile station to the unlicensed mobile access network.

32. The mobile station of claim 30, wherein respective cellular access network and unlicensed mobile access network identifications comprise at least one of an electronic serial number or an international mobile subscriber identity associated with the mobile station.

33. The mobile station of claim 30, wherein the application is further configured, upon execution, to:
receive a handoff command comprising the unlicensed mobile access network identification associated with the mobile station;
determine the cellular access network identification based at least in part on the unlicensed mobile access network identification included in the handoff command; and
transmit a handoff complete message comprising the cellular access network identification.

34. A computer program product for providing an authentication mechanism for an unlicensed mobile access network, wherein the computer program product comprises at least one computer-readable storage medium having computer-readable program code portions stored therein, the computer-readable program code portions comprising:
a first executable portion for receiving a registration request from a mobile station, the request comprising a cellular access network identification associated with the mobile station and an unlicensed mobile access network identification associated with the mobile station;
a second executable portion for mapping the cellular access network identification to the unlicensed mobile access network identification; and
a third executable portion for using the mapping to handoff between a cellular access network and the unlicensed mobile access network.

35. The computer program product of claim 34, wherein the cellular access network identification is used to contact the mobile station and to authenticate the mobile station to the cellular access network, and wherein the unlicensed mobile access network identification is used to authenticate the mobile station to the unlicensed mobile access network.

36. The computer program product of claim 34, wherein respective cellular access network and unlicensed mobile access network identifications comprise at least one of an electronic serial number or an international mobile subscriber identity associated with the mobile station.

37. The computer program product of claim 34 further comprising:
a fourth executable portion for receiving a request to handoff the mobile station from the cellular access network to the unlicensed mobile access network, said handoff request comprising the cellular access network identification associated with the mobile station.

38. The computer program product of claim 37 further comprising:
a fifth executable portion for receiving a first handoff complete message comprising the unlicensed mobile access identification associated with the mobile station.

39. The computer program product of claim 38 further comprising:
a sixth executable portion for determining the cellular access network identification associated with the mobile station based at least in part on the unlicensed mobile access network identification included in the first handoff complete message; and
a seventh executable portion for transmitting a second handoff complete message comprising the cellular access network identification.

40. The computer program product of claim 34 further comprising:
a fourth executable portion for determining the cellular access network identification associated with the mobile station based at least in part on the mapping; and
a fifth executable portion for generating a request to handoff the mobile station from the unlicensed mobile access network to the cellular access network, said handoff request comprising the cellular access network identification associated with the mobile station.

41. The computer program product of claim 40 further comprising:
a sixth executable portion for receiving a first handoff command comprising the cellular access network identification associated with the mobile station;
a seventh executable portion for determining the unlicensed mobile access network identification associated with the mobile station based at least in part on the cellular access network identification included in the first handoff command; and
an eighth executable portion for transmitting a second handoff command comprising the unlicensed mobile access network identification.

42. The computer program product of claim 41 further comprising:
a ninth executable portion for releasing a connection between the unlicensed mobile access network connection and the mobile station identified by the unlicensed mobile access network identification;
a tenth executable portion for determining the cellular access network identification associated with the mobile station based at least in part on the unlicensed mobile access network identification; and
an eleventh executable portion for transmitting a clear complete message comprising the cellular access network identification.

43. A system for providing an authentication mechanism for an unlicensed mobile access network, said system comprising:
a mobile station; and
a network entity in communication with the mobile station and configured to store a registration associated with the mobile station, said registration comprising at least two points of attachment for a serving network, a first point of attachment corresponding with a cellular access network, and a second point of attachment corresponding with the unlicensed mobile access network.

44. The system of claim 43, wherein the network entity comprises a home location register associated with the cellular access network.

45. The system of claim 44 further comprising:
a mobile switching center associated with the cellular access network and in communication with the home location register; and
an authentication, authorization and accounting server associated with the unlicensed mobile access network and in communication with the home location register, wherein the first point of attachment corresponds with the mobile switching center, and the second point of attachment corresponds with the authentication, authorization and accounting server.

46. The system of claim 43 wherein the network entity comprises an authentication, authorization and accounting server associated with the cellular access network.

47. The system of claim 46 further comprising:
a packet data serving node associated with the cellular access network and in communication with the authentication, authorization and accounting server; and
a unlicensed mobile access network controller associated with the unlicensed mobile access network and in communication with the authentication, authorization and accounting server, wherein the first point of attachment corresponds with the packet data serving node and the second point of attachment corresponds with the unlicensed mobile access network controller.

48. The system of claim 43 wherein the network entity comprises a database associated with the cellular access network, and wherein the system further comprises:
a first authentication, authorization and accounting server associated with the cellular access network and in communication with the database; and
a second authentication, authorization and accounting server associated with the unlicensed mobile access network and in communication with the database, and wherein the first point of attachment corresponds with the first authentication, authorization and accounting server and the second point of attachment corresponds with the second authentication, authorization and accounting server.

49. The system of claim 43 further comprising:
an unlicensed mobile access network controller configured to authenticate the mobile station to the unlicensed mobile access network and to enable the mobile station to communicate with the cellular access network via the unlicensed mobile access network.
